(19) United States
(12) Patent Application Publication
(10) Pub. No.: US 2020/0046598 A1
(43) Pub. Date: Feb. 13, 2020

(54) DRIVING MECHANISM FOR SEX TOY

(71) Applicant: WEN-HUNG SHEN, TAIPEI (TW)

(72) Inventor: WEN-HUNG SHEN, TAIPEI (TW)

(21) Appl. No.: 16/101,442

(22) Filed: Aug. 11, 2018

(51) Int. Cl. A61H 19/00; A61H 23/02

(52) U.S. Cl. CPC A61H 19/00; A61H 23/0254; A61H 15/0078; A61H 2201/1676; A61H 2201/1463

(57) ABSTRACT

A driving mechanism for sex toy includes a motor, a turntable with an eccentric pin rotatable by the motor, a sliding guide member drivable by the eccentric pin of the turntable to move linearly up and down upon rotation of the motor, a casing holding a locating block, two links respectively and bilaterally pivoted with respective middle part thereof to two opposite sides of the casing and respective rear ends thereof to two opposite sides of the sliding guide member, a finger plate pivotally connected between opposing front ends of the links, and a drag plate pivotally connected between the finger plate and the locating block.

### FIELD OF INVENTION

The presentation relates to sex toy technology and more particularly, to a driving mechanism for sex to which is capable of simulating a massaging, itching or irritation action of a human finger and has stable and compact, high torque, high speed, two-step finger action characteristics.

### BACKGROUND

Commercial sex toys are numerous and have the characteristics of small and compact size, ease of carrying, high stability and cheap cost. However, these commercial sex toys have the drawbacks of low torque, low rotational speed, large size and one step finger action. There is still room for improvement.

### SUMMARY OF THE DESCRIPTION

The present invention has been accomplished under the circumstances in view. It is one object of the present invention to provide a driving mechanism for sex tory, which is capable of simulating a massaging, itching or irritation action of a human finger and has stable and compact, high torque, high speed, two-step finger action characteristics.

To achieve this and other objects of the present invention, a driving mechanism for sex toy comprises a motor, a turntable with an eccentric pin rotatable by the motor, a sliding guide member drivable by the eccentric pin of the turntable to move linearly up and down upon rotation of the motor, a casing holding a locating block, two links respectively and bilaterally pivoted with respective middle part thereof to two opposite sides of the casing and respective rear ends thereof to two opposite sides of the sliding guide member, a finger plate pivotally connected between opposing front ends of the links, and a drag plate pivotally connected between the finger plate and the locating block.

Other advantages and features of the present invention will be fully understood by reference to the following specification in junction with the accompanying drawings, in which like reference signs denote like components of structure.

### BRIEF DESCRIPTION OF THE DRAWINGS

FIG. 1 is an oblique top elevational view of a driving mechanism for sex toy in accordance with the present invention.

FIG. 2 is an exploded view of the driving mechanism for sex toy in accordance with the present invention.

FIG. 3 is a side view of the driving mechanism for sex toy in accordance with the present invention.

FIG. 4 is another side view of the driving mechanism for sex toy in accordance with the present invention.

### DETAILED DESCRIPTION

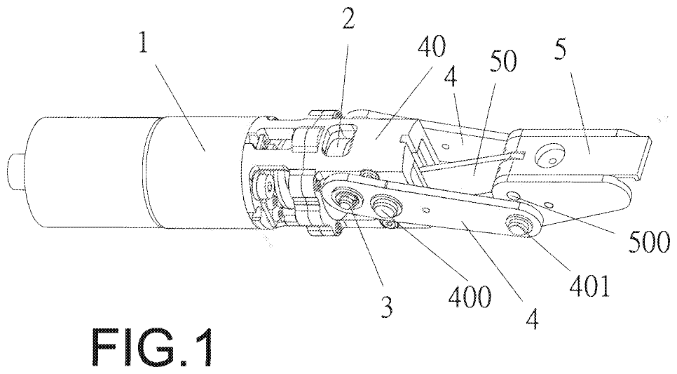

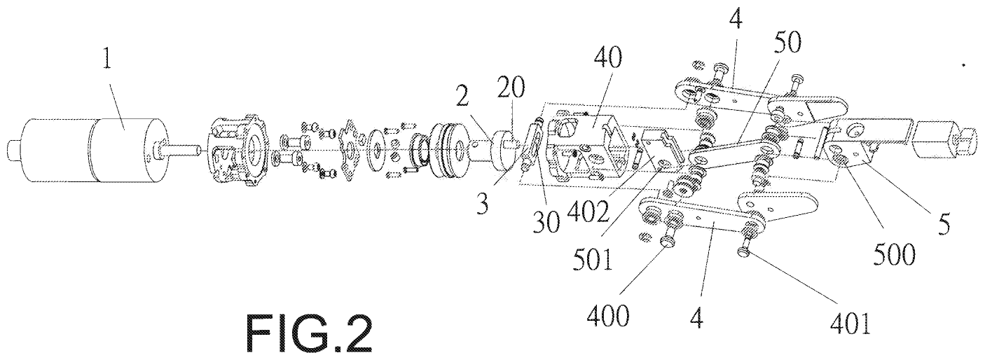

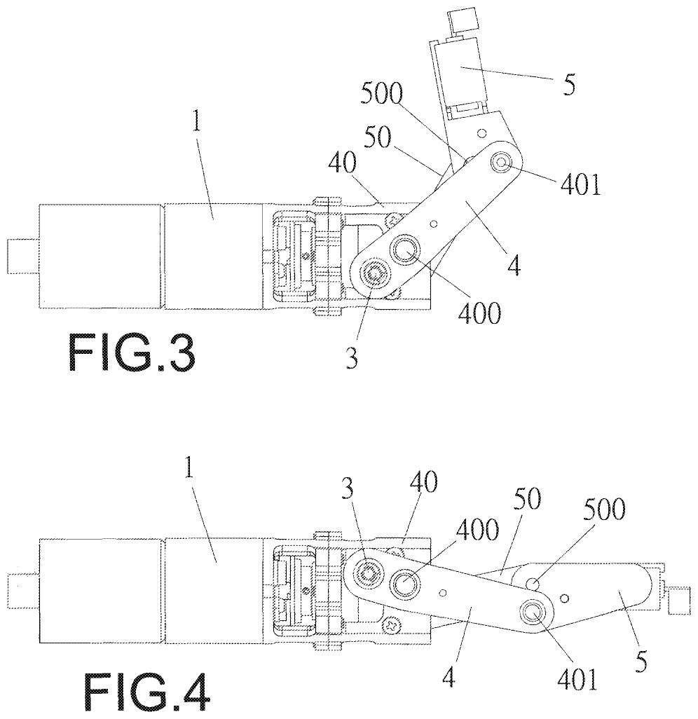

Referring to FIGS. 1-4, a driving mechanism for sex toy in accordance with the present invention is shown. The driving mechanism comprises a motor (1) controllable to rotate at a predetermined speed by a controller or a Bluetooth Low Energy (BLE) system-on-chip, a turntable (2) rotatable by the motor (1) and providing an eccentric pin (20), a sliding guide member (3) defining therein a sliding slot (30) that is coupled to the eccentric pin (20) of the turntable for causing the sliding guide member (3) to move linearly up and down upon rotation of the motor (1), a casing (40) holding a locating block (402) that provides a pivot hole (501), two links (4) respectively and bilaterally pivoted with respective rear ends thereof to two opposite sides of the sliding guide member (3), two pivot pins (400) respectively pivotally connecting respective middle parts of the links (4) to two opposite sides of the casing (40), a finger plate (5) having a pivot hole (500) located on a rear end thereof and pivotally connected between opposing front ends of the links (4) by a pivot member (401), and a drag plate (50) having a front end thereof pivotally connected to the pivot hole (500) of the finger plate (5) and an opposing rear end thereof pivotally connected to the pivot hole (501) of the locating block (402).

In application, the motor (1) is controlled by a controller or a Bluetooth Low Energy (BLE) system-on-chip to rotate the turntable (2) at a predetermined speed, causing the eccentric pin (20) to move the sliding guide member (3) alternatively up and down. During up and down reciprocating motion of the sliding guide member (3), the links (4) are driven to turn about the respective pivot pins (400) alternatively forward and backward, thereby biasing the finger member (5) up and down in a two-step manner, simulating a massaging, itching or irritation action of a human finger. Thus, the driving mechanism of the present invention has stable and compact, high torque, high speed, two-step finger action characteristics.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A driving mechanism for sex toy, comprising:
a motor;
a turntable rotatable by said motor and providing an eccentric pin;
a sliding guide member defining therein a sliding slot, said sliding slot being coupled to said eccentric pin of said turntable for causing said sliding guide member to move linearly up and down upon rotation of said motor;
a casing holding a locating block, said locating block providing a pivot hole;
two links respectively and bilaterally pivoted with respective rear ends thereof to two opposite sides of said sliding guide member;
two pivot pins respectively pivotally connecting respective middle parts of said links to two opposite sides of said casing;
a finger plate having a pivot hole located on a rear end thereof and pivotally connected between opposing front ends of said links by a pivot member; and
a drag plate having a front end thereof pivotally connected to the said pivot hole of said finger plate and an opposing rear end thereof pivotally connected to the said pivot hole of said locating block.

2. The driving mechanism of claim 1, further comprising a Bluetooth Low Energy (BLE) system-on-chip for controlling the operation of said motor wirelessly.
